(19) United States
(12) Patent Application Publication
(10) Pub. No.: US 2014/0035812 A1
(43) Pub. Date: Feb. 6, 2014

(54) GESTURE SENSING DEVICE

(71) Applicant: Maxim Integrated Products, Inc., San Jose, CA (US)

(72) Inventors: David Skurnik, Kirkland, WA (US); Nevzat A. Kestelli, San Jose, CA (US); Ilya K. Veygman, Palo Alto, CA (US); Anand Chamakura, San Jose, CA (US); Christopher F. Edwards, Sunnyvale, CA (US); Nicole D. Kerness, Menlo Park, CA (US); Pirooz Parvarandeh, Los Altos Hills, CA (US); Sunny K. Hsu, Los Altos, CA (US); Judy Lau, Palo Alto, CA (US); Ronald B. Koo, Los Altos, CA (US); Daniel S. Christman, Campbell, CA (US); Richard I. Olsen, Truckee, CA (US)

(73) Assignee: Maxim Integrated Products, Inc., San Jose, CA (US)

(21) Appl. No.: 14/048,219

(22) Filed: Oct. 8, 2013

Related U.S. Application Data
(63) Continuation-in-part of application No. 13/352,299, filed on Jan. 17, 2012.
Application No. 13/352,299 is a continuation-in-part of application No. 13/304,603, filed on Nov. 25, 2011.
(60) Provisional application No. 61/483,034, filed on May 5, 2011.
(60) Provisional application No. 61/867,221, filed on Aug. 19, 2013.

(51) Int. Cl. G06F 3/01

(52) U.S. Cl. CPC G06F 3/017
USPC 345/156

(57) ABSTRACT

A gesture sensing device having a single illumination source is disclosed. In one or more implementations, the gesture sensing device includes a single illumination source configured to emit light and a light sensor assembly configured to detect the light reflected from an object and to output time dependent signals in response thereto. The gesture sensing device also includes a processing circuit coupled to the light sensor assembly and configured to analyze the time dependent signals received from the light sensor assembly to determine object directional movement proximate to the light sensor assembly.

### CROSS-REFERENCE TO RELATED APPLICATIONS

The present application is a continuation-in-part under 35 U.S.C. §120 of U.S. patent application Ser. No. 13/352,299, filed Jan. 17, 2012, entitled “METHOD FOR DETECTING GESTURES USING A MULTI-SEGMENT PHOTODIODE AND ONE OR MORE FEWER ILLUMINATION SOURCES;” which is a continuation-in-part under 35 U.S.C. §120 of U.S. patent application Ser. No. 13/304,603, filed Nov. 25, 2011, entitled “OPTICAL GESTURE SENSOR USING A SINGLE ILLUMINATION SOURCE;” which claims priority under 35 U.S.C. §119(e) of U.S. Patent Application Ser. No. 61/483,034, filed May 5, 2011, entitled “GESTURE SENSING METHOD AND APPARATUS;” and the present application further claims priority under 35 U.S.C. §119(e) of U.S. Patent Application Ser. No. 61/867,221, filed Aug. 19, 2013, entitled “GESTURE DETECTION DEVICE HAVING AN ANGLED OPTICAL LENS.” U.S. patent application Ser. Nos. 13/352,299 and 13/304,603 and U.S. Provisional Application Ser. Nos. 61/483,034 and 61/867,221 are hereby incorporated by reference in their entireties.

### BACKGROUND

Electronic devices, such as smart phones, tablet devices, laptop and desk top computers, digital media players, and so forth, increasingly employ light sensors to control the manipulation of a variety of functions provided by the device. For example, light sensors are commonly used by electronic devices to detect ambient lighting conditions in order to control the brightness of the device's display screen and the keyboard. Typical light sensors employ photo sensors, such as photodiodes, phototransistors, or the like, which convert received light into an electrical signal (e.g., a current or voltage, analog or digital).

Light sensing devices are commonly used in gesture or proximity sensing devices. Gesture sensing (e.g., detection) devices enable the detection of physical movement largely parallel to the display surface (e.g., “gestures”) without the user actually touching the device within which the gesture sensing device resides. Proximity sensing devices enable the detection of physical movement that is largely perpendicular to the display surface (e.g., proximate to the display surface). The detected movements can be subsequently used as input command for the device. In implementations, the electronic device is programmed to recognize distinct non-contact hand motions, such as left-to-right, right-to-left, up-to-down, down-to-up, in-to-out, out-to-in, and so forth. Gesture and proximity sensing devices have found popular use in handheld electronic devices such as tablet computing devices and smart phones, as well as other portable electronic devices such as laptop computers, video game consoles, and so forth.

### SUMMARY

A gesture sensing device having a single illumination source is disclosed. In one or more embodiments, the gesture sensing device includes a light sensor assembly configured to detect the light emitted by the single illumination source that is reflected from an object, and to output time dependent signals in response thereto. The gesture sensing device also includes a processing circuit coupled to the light sensor assembly and configured to analyze the time dependent signals received from the light sensor assembly to determine object directional movement proximate to the light sensor assembly.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items.

FIG. 1 illustrates a simplified block diagram of a conventional gesture sensor.

FIG. 2 illustrates an exemplary method for detecting a moving target using the gesture sensor of FIG. 1.

FIG. 3A illustrates a conceptual diagram of the gesture sensing device according to an example implementation of the present disclosure.

FIG. 3B illustrates a diagrammatic plan view of an illumination source assembly utilized by the gesture sensing device in accordance with an example implementation of the present disclosure.

FIG. 3C is a diagrammatic cross-sectional view illustrating the illumination source assembly shown in FIG. 3B in accordance with an example implementation of the present disclosure.

FIG. 3D is another diagrammatic cross-sectional view illustrating the illumination source assembly shown in FIG. 3B in accordance with an example implementation of the present disclosure.

FIG. 3E is a diagrammatic side view illustrating a light sensor assembly having a microlens disposed over the light sensor assembly in accordance with an example implementation of the present disclosure.

FIGS. 4 and 5 illustrate exemplary composite signals generated from signals output from the segmented photo sensor in response to a target moving in various directions.

FIG. 6 illustrates a diagrammatic cross-sectional view of a sundial configuration in accordance with an example implementation of the present disclosure.

FIG. 7 illustrates a diagrammatic top down view of the cell of FIG. 6.

FIG. 8 illustrates the cell of FIG. 7 rotated by 90 degrees.

FIG. 9 illustrates a diagrammatic top down view of a plurality of cells configured to form four segments.

FIG. 10 illustrates a diagrammatic cross-sectional view of a light modifying structure employing a sundial configuration in accordance with an example implementation of the present disclosure.

FIG. 11 illustrates a diagrammatic cross-sectional view of the light modifying structure employing the sundial configuration in accordance with another example implementation of the present disclosure.

FIG. 12 illustrates a diagrammatic cross-sectional view of a light modifying structure employing a pinhole configuration in accordance with an example implementation of the present disclosure.

FIG. 13 illustrates a diagrammatic top down plan view of the cell of FIG. 12.

FIG. 14 illustrates a diagrammatic cross-sectional view of a light modifying structure employing a canopy configuration in accordance with an example implementation of the present disclosure.

FIG. 15 illustrates a diagrammatic top down view of a light modifying structure employing a corner quad configuration in accordance with an example implementation of the present disclosure.

FIG. 16 illustrates a diagrammatic cross-sectional view of the light modifying structure employing the corner quad configuration of FIG. 15.

FIG. 17 illustrates a diagrammatic side view of a light modifying structure employing a Venetian blinds configuration according to an example implementation of the present disclosure.

FIG. 18 illustrates a diagrammatic side view of adjacent cells having the light modifying structure employing the Venetian blinds configuration disposed over one or more cells according to an example implementation of the present disclosure.

FIG. 19 illustrates a diagrammatic top down view of a micro quad cell configuration according to an example implementation of the present disclosure.

FIG. 20 illustrates an example waveform corresponding to left to right image motion across the segmented sensor of FIG. 3.

FIG. 21 illustrates an example waveform corresponding to up to down image motion across the segmented sensor while the target motion is from right to left as in FIG. 20.

FIG. 22 illustrates an example waveform corresponding to left to right image motion across the segmented sensor while the target motion is from down to up as in FIG. 23.

FIG. 23 illustrates an example waveform corresponding to up to down image motion across the segmented sensor of FIG. 3.

FIGS. 24-27 illustrate waveforms similar to the waveforms of FIGS. 20-23, respectively, except that the target motion corresponding to the waveforms in FIGS. 24-27 is faster than the target motion corresponding to the waveforms in FIGS. 20-23.

FIG. 28 illustrates four Gaussian distributions corresponding to recognized directions left, right, up, and down.

FIG. 29 illustrates an example 4×4 array of photodiode segments in accordance with an example implementation of the present disclosure.

### DETAILED DESCRIPTION

Overview

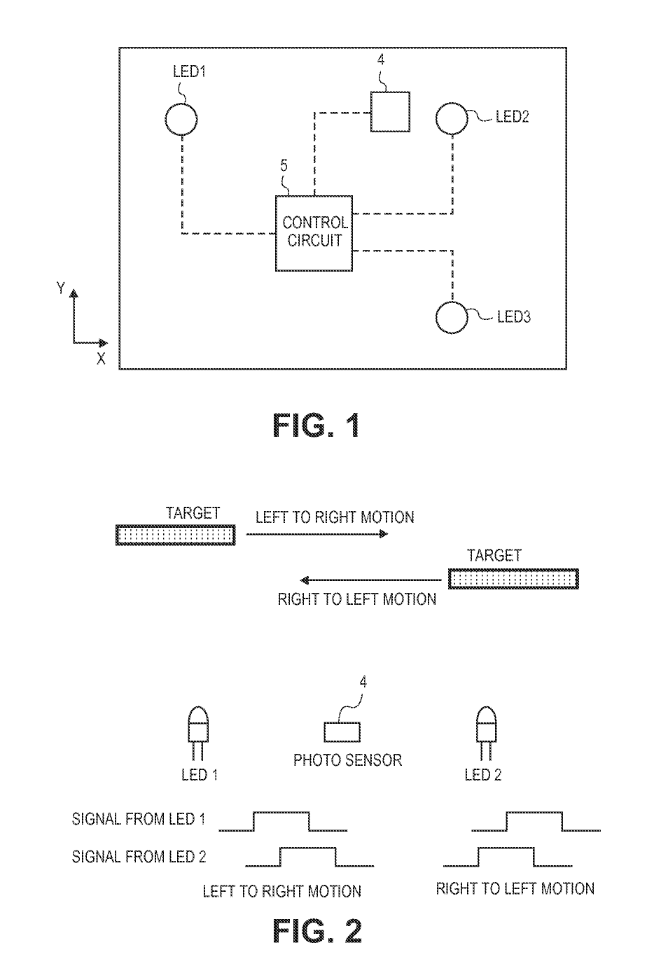

Some gesture sensor implementations utilize three or more illumination sources and a light sensor employed on a flexible circuit board. The illumination sources are turned on and off, or flashed, in succession in order for the sensor to obtain spatial information from reflection of the flashed light. FIG. 1 illustrates a simplified block diagram of a conventional gesture sensor. A photo sensor 4 is positioned proximate LED 1, LED 2, and LED 3. A control circuit 5 is programmed to successively turn on and off the LEDs 1 through 3 and analyze the resulting measurements sensed by the photo sensor 4. FIG. 2 illustrates an example method for detecting a moving target using the gesture sensor of FIG. 1. The motion is detected by observing the relative delay between sensed signals from the same-axis LEDs. For example, to detect left to right or right to left motion, the signals sensed by the LEDs 1 and 2 are compared, as shown in FIG. 2. LED 1 is flashed at a different time than LED 2. The LEDs 1 and 2 are positioned in known locations and are turned on and off in a known sequence. When the light from the LEDs strikes a target moving above the LEDs, light is reflected off the moving target back to the photo sensor 4. The sensed reflected light is converted to a voltage signal which is sent to the control circuit 5. The control circuit 5 includes an algorithm that uses the LED positions, the LED firing sequences, and the received sensed data to determine relative movement of the target.

FIG. 2 shows the sensed voltage signals for the case of left to right motion. A sensed voltage signal is a voltage versus time curve. The curve labeled “Signal from LED 1” shows the sensed voltage resulting from repeated flashes of the LED 1. The low portion of the curve indicates the target is not passing over, or near, the LED 1. In other words, the target is not within the “field of view” of the photo sensor 4 whereby light emitted from the LED 1 can be reflected off the target and onto the photo sensor 4. If the target is not within the field of view of the photo sensor 4 as related to the LED 1, the photo sensor 4 does not sense any reflections of light emitted from LED 1. The high portion of the curve indicates the target is passing over, or near, the LED 1. The curve labeled “Signal from LED 2” shows the sensed voltage resulting from repeated flashes of the LED 2. While LED 1 is on, LED 2 is off, and vice versa. While the target is positioned over, or near, LED 1, the sensed voltage related to flashing of LED 1 is high, but the sensed voltage related to flashing of the LED 2 is low. While the target is positioned in the middle, between the two LEDs 1 and 2, the photo sensor 4 detects reflected light from flashing of both LED 1 and LED 2. While the target is positioned over, or near, LED 2, the sensed voltage related to flashing of LED 2 is high, but the sensed voltage related to flashing of the LED 1 is low. When the target is not positioned over either LED 1 or LED 2 or between LED 1 and LED 2, the photo sensor 4 does not sense reflected light associated with either and the corresponding sensed voltage levels are low.

For left to right motion, the sensed voltage level for “signal from LED 1” goes high before the sensed voltage level for “signal from LED 2”, as shown in FIG. 2. In other words, the voltage versus time curve of “signal from LED 2” is delayed relative to the voltage versus time curve of “signal from LED 1” when the target is moving from left to right.

FIG. 2 also shows the sensed voltage signals for the case of right to left motion. For right to left motion, the sensed voltage level for “signal from LED 2” goes high before the sensed voltage level for “signal from LED 1”, as shown in the two voltage versus time curves on the left hand side of FIG. 2. In other words, the voltage versus time curve of “signal from LED 1” is delayed relative to the voltage versus time curve of “signal from LED 2” when the target is moving from right to left.

Up and down motion, where up and down are considered to be motion in the y-axis, is similarly determined using LEDs 2 and 3 and the corresponding voltage versus time data. The control circuit 5 receives the sensed voltage from the photo sensor 4 and determines relative target motion in the y-axis in a similar manner as that described above in relation to the x-axis.

A disadvantage of the multiple illumination source configuration is the flexible circuit board employing the multiple illumination sources must be integrated with the device. With ever decreasing device size, additional components are undesirable.

Accordingly, a gesture sensing device having a single illumination source integrated within a single integrated circuit package is disclosed. In one or more implementations, the gesture sensing device includes a single illumination source and a light sensor assembly. The light sensor assembly is configured to detect the light emitted by the single illumination source that is reflected from an object and to output time dependent signals in response thereto. The gesture sensing device also includes a processing circuit coupled to the light sensor assembly and configured to analyze the time dependent signals received from the light sensor assembly to determine object directional movement proximate to the light sensor assembly.

In embodiments, the illumination source may be a light emitting diode (LED), a vertical-cavity surface-emitting laser (VCSEL), and so forth. In an implementation, the light sensor assembly may comprise photodiodes, phototransistors, or the like. The light sensor assembly can be an array of individual light sensors or a single light sensor partitioned into multiple segments. In one or more specific implementations, the gesture sensing device may include a light modifying structure. In some embodiments, the light modifying structure is an optical lens structure. In other embodiments, the light modifying structure is a mechanical structure configured to selectively block a portion of the light depending on a position of the target object relative to the plurality of light sensors. In the case of a mechanical structure, respective light sensors can be formed as a plurality of cell structures where the cell structure comprises two photodiodes. The mechanical structure can include a plurality of wall structures. In some implementations, the device includes one wall structure per cell where the wall structure is positioned between the two photo diodes. In some embodiments, a top layer of the wall structure has an outer perimeter that does not overlap either of the two photodiodes. In other embodiments, a top layer of the wall structure has an outer perimeter that partially covers the two photodiodes. Wall structures can include a plurality of metal layers and a plurality of dielectric layers, a dielectric layer separating the metal layers, where one or more dielectric layers include a plurality of metal through-vias that couple to metal layers on either side of the dielectric layer. In some embodiments, the plurality of wall structures are fabricated using semiconductor manufacturing processes.

In some embodiments, one or more wall structures are perpendicular to a top surface of the one or more photodiodes. In other embodiments, one or more light sensors include a plurality of cell structures, and one or more cell structures include one or more photodiodes. The mechanical structure may include a plurality of wall structures, one wall structure per cell where the wall structure is at a non-perpendicular angle to a top surface of the one or more photodiodes. In this non-perpendicular configuration, respective wall structures can include a plurality of metal layers and a plurality of through-vias configured in a stair-step structure.

In some embodiments, respective light sensors include a plurality of cell structures, and the cell structures may include two photodiodes. The mechanical structure may include a plurality of slotted metal layers, one slotted metal layer per cell wherein the slotted metal layer is positioned above the two photo diodes and an open slot of the slotted metal layer is aligned with a center point between the two photodiodes. Respective cells can also include a dielectric layer positioned between the photodiodes and the slotted metal layer, wherein the dielectric layer is optically transparent. In other embodiments, the plurality of light sensors are formed on an integrated circuit chip, and each light sensor is a photodiode, further wherein the mechanical structure includes a chip package coupled to the integrated circuit chip, the chip package including a wall structure positioned between each of the photodiodes.

The control circuit may utilize one or more algorithms configured to calculate one of more differential analog signals using the sensed voltage signals output from the segmented photo sensors. In some embodiments, a vector is determined according to the calculated differential analog signals, the vector is used to determine a direction and/or velocity of the target motion.

In another implementation, a method of detecting a gesture is disclosed. The method includes configuring a segmented sensor having a plurality of segments that each output a segment signal corresponding to light sensed by the segment and calculating one or more differential signals according to the segment signals output from the plurality of segments. The method may also include determining a target motion direction of a target passing the segmented sensor by applying vector analysis to the one or more differential signals.

The method can also include determining a proportional value of a target motion velocity of the target passing the segmented sensor by applying vector analysis to the one or more differential signals. In some embodiments, the light sensed by the segment comprises light originated from an illumination source and reflected off the target. In other embodiments, the light sensed by the segment comprises ambient light. In some embodiments, the one or more differential signals comprise one or more differential composite signals, wherein a composite signal is a signal formed from the addition of two or more segment signals.

Calculating one or more differential signals can include calculating a first differential signal indicating the target motion direction along an x-axis. In some embodiments, the first differential signal includes a positive maximum value and a negative maximum value. The target motion direction can be determined to be in a positive x-direction if the positive maximum value precedes the negative maximum value in time, and the target motion direction can be determined to be in a negative x-direction if the negative maximum value precedes the positive maximum value in time. Calculating one or more differential signals can include calculating a second differential signal indicating the target motion direction along a y-axis. In some embodiments, the second differential signal includes a positive maximum value and a negative maximum value. The target motion direction can be determined to be in a positive y-direction if the positive maximum value precedes the negative maximum value in time, and the target motion direction can be determined to be in a negative y-direction if the negative maximum value precedes the positive maximum value in time.

The method can also include calculating a proportional value of a target motion velocity along the x-axis using a time difference between successive zero crossings of the first differential signal, and calculating a proportional value of a target motion velocity along the y-axis using a time difference between successive zero crossings of the second differential signal. The method can also include superimposing the proportional value of the target motion velocity along the x-axis and the proportional value of the target motion velocity along the y-axis to form a target vector. The method can also include determining one of a predefined set of directions according to the target vector. The predefined set of directions can include a positive x-direction, a negative x-direction, a positive y-direction, and a negative y-direction. In some embodiments, the target vector has a target vector angle and determining one of the predefined set of directions comprises comparing the target vector angle to a set of defined threshold angles. In other embodiments, determining one of the predefined set of directions comprises comparing the target vector to a set of predefined distribution patterns, each distribution pattern corresponding to one of the directions in the predefined set of directions. In this embodiment, comparing the target vector can include determining a confidence value associated with comparing the target vector to each distribution pattern, and selecting one of the predefined set of directions according to the highest confidence value.

In another implementation, an apparatus is disclosed that includes a segmented sensor having a plurality of segments that each output a segment signal corresponding to light sensed by the segment and a memory configured to store the segment signals. The apparatus also includes a processor coupled to the memory. The processor executes program instructions, which may be stored in the memory, and which are configured to cause the processor to calculate one or more differential signals according to the segment signals output from the plurality of segments and determine a target motion direction of a target passing the segmented sensor by applying vector analysis to the one or more differential signals.

In some implementations, the gesture sensing device may comprise a single illumination source configured to emit a light and a light sensor assembly having a processing circuit. The light sensor assembly is configured to detect the light reflected from an object proximate to the light sensor assembly (e.g., detect the light reflected from an object proximate to the device), to compute time dependent signals in response to the light detected, and to analyze the time dependent signals to determine directional movement of the object.

Example Implementations

Embodiments of the present application are directed to a gesture sensing device and corresponding techniques for detecting gestures. Reference will now be made in detail to implementations of the gesture sensing device as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions will likely be made in order to achieve the developer's specific goals, such as compliance with application and business related constraints, and that these specific goals can vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Embodiments of a gesture sensing device include a single illumination source and a light sensor assembly (e.g., an array of photo sensors). In some implementations, a tight modifying structure, such as an optical lens structure or a mechanical structure, may be utilized such that light reflected from a proximate target, such as a hand or finger, can be focused and/or directed onto different segments of the light sensor depending on the target position relative to the light sensor. The different segments of the light sensor sense reflected light at the same time to generate time dependent signals in response thereto, and the relative amplitude from each segment is indicative of movement of the target. A control circuit receives and processes the time dependent signals from the light sensor assembly to determine target motion relative to the light sensor assembly. An advantage of the gesture sensing device is that a user can convey a device command through gesturing without the need to activate a touch screen controller, or use of mechanical buttons, which provides significant power and cost savings.

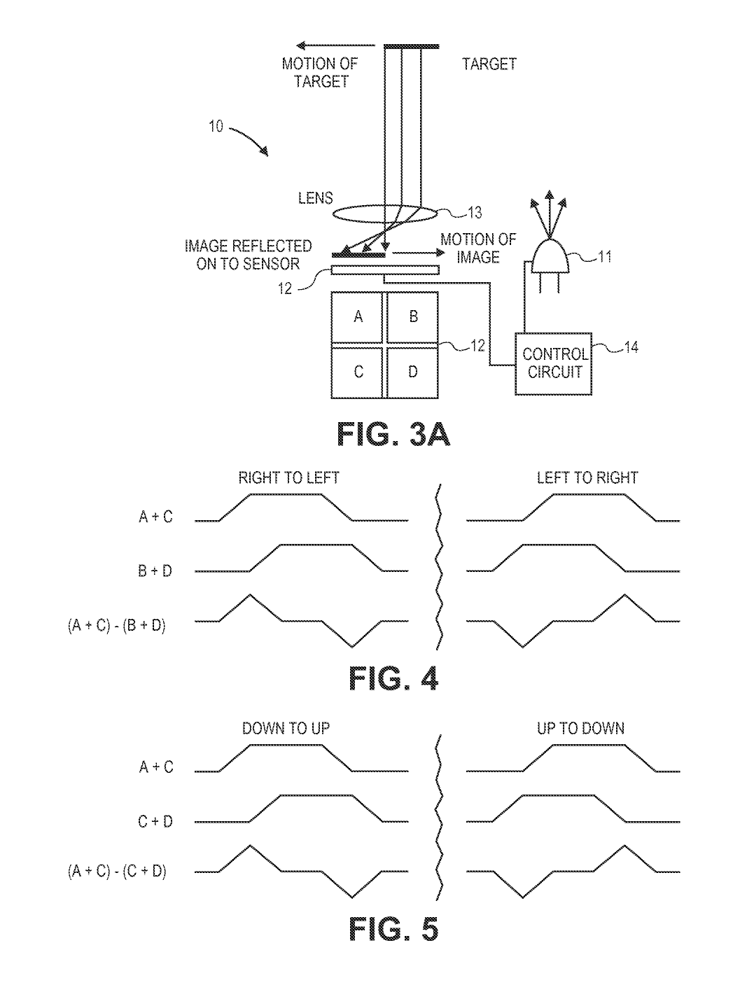

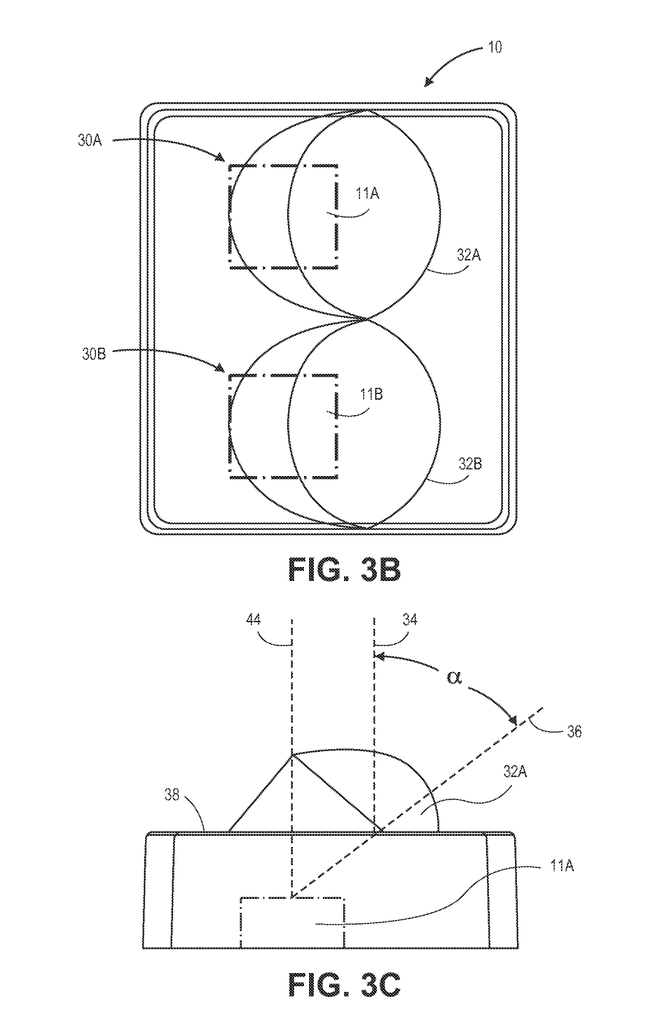

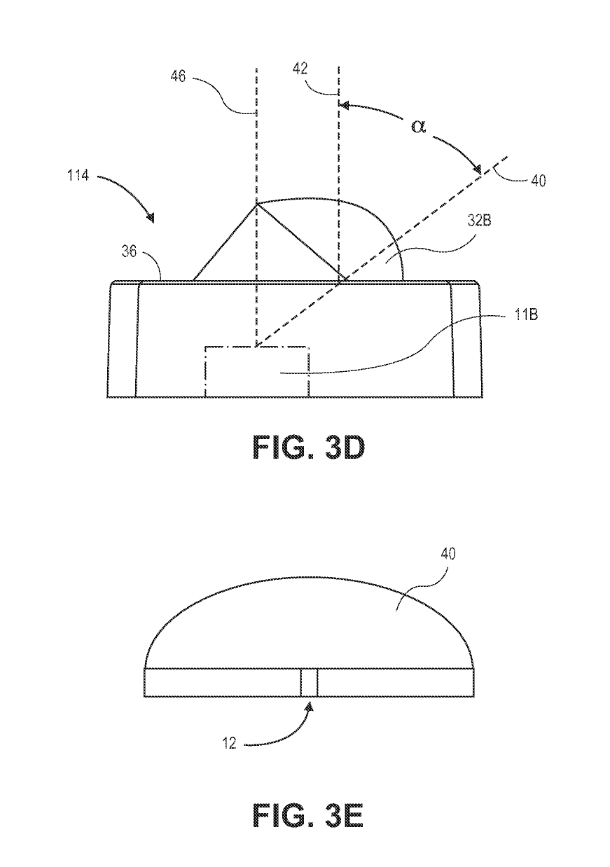

FIG. 3A illustrates a conceptual diagram of the gesture sensing device according to an embodiment. In a specific embodiment of the present disclosure, the gesture sensing device 10 includes a single illumination source, represented as a light source 11, and a segmented photo sensor 12. The light source 11 is configured to emit electromagnetic radiation occurring within a limited spectrum of wavelengths. For example, the light source 11 may emit electromagnetic radiation occurring within the visible light spectrum. In another example, the light source 11 may emit electromagnetic radiation occurring within the non-visible light spectrum (e.g., infrared light). In one or more implementations, the light source 11 comprises one or more light emitting diodes (LEDs), one or more vertical-cavity surface-emitting lasers (VCSELs), or the like. In some implementations, the single illumination source (e.g., the light source 11) may employ one or more VCSELs to provide a greater range of operation than that provided by a single illumination source employing one or more LEDs (e.g., operated at the same power). Moreover, in such implementations, the use of a single illumination source employing one or more VCSELs allows for the collimation of light in a manner that is not possible using a single illumination source employing one or more LEDs. In some implementations, the single illumination source may include two or more light sources 11. For example, the single illumination source may include two or more light sources 11 that are positioned proximate to one another so that light is emitted from a single source (e.g., single point, single area, etc.). Additionally, the single illumination source may include two or more light sources 11 that are configured to emit light at different time intervals and/or to emit light having different wavelengths. In implementations, the single illumination source may include one or more light sources 11 of a first type (e.g., an LED) and one or more light sources 11 of a second type (e.g., a VCSEL).

FIGS. 3B through 3D illustrate a single illumination source employing a plurality of light source assemblies 30 (e.g., light source assemblies 30A, 30B). The light source assemblies 30A, 30B include a respective light source 11 (e.g., light sources 11A, 11B) and a respective optical lens structure 32A, 32B. For example, the optical lens structures 32A, 32B may be configured to collimate the light incident on the optical lens structures 32A, 32B. In one or more implementations, the optical lens structures 32A, 32B may be a glass lens, a plastic lens, a spherical lens, an aspherical lens, a Fresnel-type lens, or the like. As shown in FIG. 3C, the optical lens structures 32A, 32B are oriented at an angle with respect to an axis 34 that is defined perpendicular to the front surface 36 of the device. In an implementation, the first optical lens structure 32A may be oriented at an angle α (e.g., angle axis 36) with respect to an axis 34 that is defined perpendicular to the front surface 38 of a device (see FIG. 3C), and the second optical lens structure 32B may be oriented at an angle β (e.g., angle axis 40) with respect to an axis 42 that is defined perpendicular to the front surface 36 of the device (see FIG. 3D). FIGS. 3C and 3D also illustrate respective focal point axes 44, 46 to define an approximate focal point of the corresponding light sources 11A, 11B. In an implementation, the angles α and β may range between zero degrees (0°) and about thirty-five degrees (35°). In a specific implementation, the optical lens structures 32A, 32B are oriented at an angle of about twenty degrees (20°) with respect to the axis 36. For example, the angle α can range from about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35° to about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°. In another example, the angle can range from about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35° to about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°. The orientation of the optical lens structures 32A, 32B may allow the gesture sensing device 10 to detect electromagnetic radiation reflected from an object. For example, the orientation of the optical lens structures 32A, 32B may collimate light furnished by the light source 11 such that a greater intensity of light is furnished at least partially over the gesture sensing device 10. Thus, gestures performed by the object may be detected over a greater portion of the device 10 as compared to gesture sensing devices where the illumination source emits electromagnetic radiation directly above the device (e.g., maximum intensity of electromagnetic radiation is directly above the sensor). In some implementations of the present disclosure, the angles α and β may differ to provide greater illumination coverage over the device 10 (e.g., optical lens structure 32A is oriented at a first angle α, and the optical lens structure 32A is oriented at a second angle β that differs from the first angle α).

In some implementations of the present disclosure, the light source assembly 30A is configured to emit electromagnetic radiation occurring in a first limited spectrum of wavelengths, and the light source assembly 30B is configured to emit electromagnetic radiation occurring in a second limited spectrum of wavelengths (e.g., the light source assembly 30A emits infrared light occurring with a first limited spectrum of infrared light wavelengths, and the light source assembly 30B emits infrared light occurring with a second limited spectrum of infrared light wavelengths). In some implementations of the present disclosure, the light source assembly 30A and the light source assembly 30B are configured to emit electromagnetic radiation at differing time intervals (e.g., the light source assembly 30A emits electromagnetic radiation during a first time interval, and the light source assembly 30B emits electromagnetic radiation during a second time interval).

Referring to FIG. 3A, in some embodiments, the segmented photo sensor 12 is configured to sense only a specific wavelength or wavelengths of light (e.g., electromagnetic radiation), such as the wavelengths emitted by the light source 11. Such a configuration can be implemented through the use of a filter. The segmented photo sensor 12 can be either a single sensor functionally partitioned into multiple segments or an array of individual photo sensors. For example, a quad segmented photo sensor is functionally equivalent to four individual photo sensors arranged in a quad layout. As used herein, reference to a “segment” refers to either a partitioned segment within a single sensor or to an individual sensor in an array of sensors. FIG. 3A shows the segmented photo sensor 12 in both an on-edge view (upper element labeled 12) and a plan view to show the different segments (lower element labeled 12).

In the example configuration of FIG. 3A, the segmented photo sensor 12 includes four segments, segment A, segment B, segment C, and segment D. Although a four segment detector is the simplest implementation, it is understood that the number of segments can be increased to increase the resolution of the system. The signal processing electronics become increasingly more complex as the number of segments is increased. In some implementations, respective segments are isolated from each other. The light source 11 is positioned proximate to the segmented photo sensor 12. When a moving target passes proximate to the light source 11 and into a corresponding field of view of the segmented photo sensor 12, light output from the light source 11 is reflected of the moving target and to the segmented photo sensor 12. The gesture sensing device 10 also includes an optical lens structure 13 to focus light onto the segmented photo sensor 12. The focusing lens focuses reflected light from a moving target, such as a hand gesture, in the space above the segmented photo sensor 12. It is understood that only reflected light that is within the “field of view” is focused onto the segmented photo sensor 12. Although shown as a single element 13 in FIG. 3A, the optical lens structure 13 represents any number of lens and/or optical elements for directing light to the segmented photo sensor 12. An example implementation of an optical lens structure and/or light sensor is described in the co-owned and co-pending U.S. Provisional Patent Application Ser. No. 61/490,568, filed May 26, 2011, and entitled “Light Sensor Having Glass Substrate With Lens Formed Therein” and the co-owned and co-pending U.S. Provisional Patent Application Ser. No. 61/491,805, filed May 31, 2011, and entitled “Light Sensor Having Glass Substrate With Lens Formed Therein”, which are both incorporated in their entireties by reference. Respective segments of the segmented photo sensor 12 output a segment signal to a control circuit 14, where the segment signals are processed. In one or more implementations, the control circuit 14 may be coupled to the photo sensor 12. In other implementations, the control circuit 14 may be integral with the photo sensor 12. For example, the light sensor assembly may have an integrated processing circuit (e.g., the light sensor assembly and the processing circuit are part of the same integrated chip).

The light source 11 is continuously or periodically energized to illuminate the target. The light reflected from the target induces the segment signal on the segmented photo sensors. These segment signals are processed and stored in a buffer memory, the buffer memory being integrated with or separate from the control circuit 14. The control circuit 14 analyzes the stored data and determines if a valid gesture has been detected. The same data can also be used so that the segmented photo sensor 12 operates as a proximity detector. The same photo sensor structure can be used with a different signal processing circuit so that the gesture sensing device also functions as an ambient light sensor.

When the light source 11 is powered on, or flashes, the target is illuminated if the target is within a proximate space above the segmented photo sensor 12. The moving target is conceptually illustrated in FIG. 3A as a flat reflector. The target reflection is imaged by the optical lens structure 13 onto the segmented photo sensor 12. The example of FIG. 3A illustrates a right to left motion of the target. As the edge of the target moves through the center of the imaging zone, the focused image of the target edge moves across the segmented photo sensor 12. The segments A and C respond first to the moving image, followed by segments B and D. The control circuit 14 is programmed to detect this sequence of events, and recognizes a right to left target motion. Similarly, a left to right target motion can be recognized by the opposite sequence, and both up to down and down to up target motions can be recognized using the orthogonal set of signals. In and out target motion can be recognized by sensing the absolute amplitude of the sum of the four segments A-D, which is also the proximity measurement.

In one or more implementations of the present disclosure, as shown in FIG. 3E, the device 10 may employ a microlens 40 that is disposed over the segmented photo sensor 12. The microlens 40 is configured to focus and to transmit light (e.g., electromagnetic radiation) incident thereon. For example, the microlens 40 may collimate light incident on the microlens 40 onto the sensor 12. In one or more implementations, the microlens 40 may be a glass lens, a plastic lens, a spherical lens, an aspherical lens, a Fresnel-type lens, or the like.

FIGS. 4 and 5 illustrate example composite signals generated from signals output from the segmented photo sensor 12 in response to a target moving in various directions. A composite signal is a composite of two or more segment signals, and the respective segment signals provide sensed voltage versus time data. The composite signals and method of analyzing the composite signals shown in FIGS. 4 and 5 show one example method of how to analyze the segment signals for determining target motion. It is understood that other methods of analysis can be applied to the segment signals to determine relative target motion.

Referring to FIG. 4, to determine if a target is moving from right to left or from left to right, the segment signals from segment A and segment C are added together to form composite signal A+C, and the segment signals from segment B and segment D are added together to form composite signal B+D. FIG. 4 illustrates example composite signals corresponding to the determination of right to left or left to right motion of the target. The composite signal B+D is subtracted from the composite signal A+C to form a differential composite signal (A+C)−(B+D). If right to left motion is present, the differential composite signal (A+C)−(B+D) has a positive peak followed by a negative peak, as shown in the bottom left curve of FIG. 4. If left to right motion is present, the differential composite signal (A+C)−(B+D) has a negative peak followed by a positive peak, as shown in the bottom right curve of FIG. 4.

In FIG. 3A, the direction of motion of the target is opposite that of the direction of motion of the image on the segmented photo sensor 12. Image inversion is a result of the optical lens structure 13. In one or more embodiments, described in detail below, the optical lens structure may be replaced by one of a number of mechanical structures. In some embodiments, the image on the segmented photo sensor 12 moves in the same direction as the target, and the composite signals (A+C) and (B+D) shown in FIG. 4 are swapped and the differential composite signal (A+C)−(B+D) is inverted. As shown in FIG. 3A, when the target moves from right to left, the image on the segmented photo sensor 12 moves from left to right. As applied to FIG. 4, when the target moves from right to left, then the image initially appears on segments A and C as the target is on the right, but the image does not yet appear on segments B and D, and the resulting composite signal A+C starts to increase, as shown in the top left curve of FIG. 4, but the composite signal A+C remains at zero. As the target moves to the left, the image starts to appear on segment B+D while still appearing on segments A+C, and the resulting composite signal B+D starts to increase, as shown in the middle left curve of FIG. 4. Eventually, the image fully appears on all segments A−D. When the trailing edge of the target image moves off of segments A and C, the composite signal A+C returns to zero, and the negative peak of the differential composite signal (A+C)−(B+D) is formed.

Similarly, when the target moves from left to right, then the image initially appears on segments B and D as the target is on the left, but the image does not yet appear on segments A and C, and the resulting composite signal B+D starts to increase, as shown in the top right curve of FIG. 4, but the composite signal A+C remains at zero. As the target moves to the right, the image starts to appear on segment A+C while still appearing on segments B+D, and the resulting composite signal A+C starts to increase, as shown in the middle right curve of FIG. 4. Eventually, the image fully appears on all segments A−D. When the trailing edge of the target image moves off of segments B and D, the composite signal B+D returns to zero, and the positive peak of the differential composite signal (A+C)−(B+D) is formed.

Up and down movement is similarly determined. To determine if a target is moving from up to down or from down to up, the segment signals from segment A and segment B are added together to form composite signal A+B, and the segment signals from segment C and segment D are added together to form composite signal C+D. FIG. 5 illustrates example composite signals corresponding to the determination of up to down or down to up motion of the target. The composite signal C+D is subtracted from the composite signal A+B to form a differential composite signal (A+B)−(C+D). If down to up motion is present, the differential composite signal (A+B)−(C+D) has a positive peak followed by a negative peak, as shown in the bottom left curve of FIG. 5. If up to down motion is present, the differential composite signal (A+B)−(C+D) has a negative peak followed by a positive peak, as shown in the bottom right curve of FIG. 5.

When the target moves from down to up, then the image initially appears on segments A and B, but the image does not yet appear on segments C and D. The resulting composite signal A+B starts to increase, as shown in the top left curve of FIG. 5, but the composite signal C+D remains at zero. As the target moves downward, the image starts to appear on segment C+D while still appearing on segments A+B, and the resulting composite signal C+D starts to increase, as shown in the middle left curve of FIG. 5. Eventually, the image fully appears on all segments A−D. As in the right to left motion, with down to up motion the differential composite signal (A+B)−(C+D) exhibits a positive peak followed by a negative peak, as shown in the bottom left curve of FIG. 5. It can be easily seen that the opposite motion, up to down, forms a similar differential composite signal (A+B)−(C+D), hut with the opposite phase, as shown in the bottom right curve of FIG. 5.

Additional processing is performed to determine motion toward and away from the segmented photo sensor, referred to as in and out motion. To determine in and out motion, all four segments A, B, C, D are added to form a composite signal A+B+C+D. If the composite signal A+B+C+D increases over a given time period, then it is determined that there is motion toward the segmented photo sensor, or inward. If the composite signal A+B+C+D decreases over a given time period, then it is determined that there is motion away from the segmented photo sensor, or outward.

In general, the segments are measured and the segment signals are processed as appropriate to determine changes in magnitude of the composite signals. These changes in magnitude, when compared temporally with changes in magnitude of other composite signals, determine relative motion of a target reflecting light back to the segmented photo sensor.

in some embodiments, mechanical structures are used in place of the optical lens structure. Mechanical structures are used to influence how the reflected light is directed to the segmented photo sensor. A first mechanical structure is referred to as a sundial configuration. The sundial configuration implements a physical “wall” protruding from a sensor surface of the segmented photo sensor. The wall effectively casts a “shadow” on various sensor segments as the target moves across the space above the segmented photo sensor. This shadow is tracked and target motion is correspondingly determined.

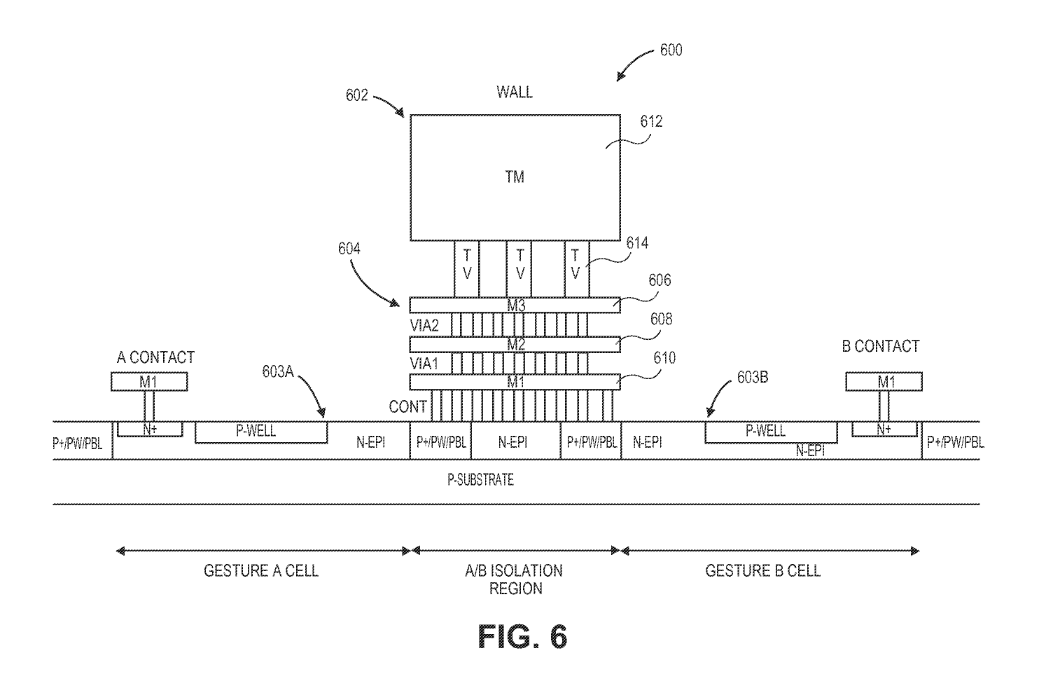

FIG. 6 illustrates a cross-sectional view of a mechanical structure 600 employing a sundial configuration according to an embodiment of the present disclosure. The sundial mechanical structure 600 is configured to direct reflected light onto a photo sensor. The center structure 602 comprises a physical sundial wall 604 used to block reflected light. The two N-EPI to P-SUBSTRATE junctions 603A, 603B on either side of the wall 604 fbrm two photosensors (e.g., photodiodes) The wall 604 comprises a series of metal layers 606, 608, 610, 612 built up to separate the two photosensors. In the example configuration of FIG. 6, the wall includes a first metal layer M1, a second metal layer M2, a third metal layer M3, and a top metal layer TM. The metal layers are separated by a passivation layer, such as silicon dioxide, within which through-vias 614 are formed. The metal layers, passivation layers, and through-vias are formed using conventional semiconductor processing techniques. The wall is formed on a substrate doped to form the photodiodes, also referred to as a gesture cell. The first photodiode, or gesture cell A, is formed by an N-EPI to P-SUBSTRATE junction. A metal contact M1 is coupled to the N-EPI region in order to make contact to the photodiode cell A cathode. The P-SUBSTRATE serves as the photodiode anode, and it is common for both the photodiode cells A and B cells. There is an additional photodiode formed by adding a P-WELL layer on top of the N-EPI layer of gesture cell A. A contact for the P-well is made at the end of the P-well. In some embodiments, the P-well photodiode is used to measure ambient light when the gesture function is not used. Such a configuration and functionality is described in the co-owned U.S. patent application Ser. No. 12/889,335, filed on Sep. 23, 2010, and entitled “Double Layer Photodiodes in Ambient Light Sensors and Proximity Detectors”, which is hereby incorporated in its entirety by reference. The second photodiode B, or gesture cell is formed in a manner identical to the photodiode A cell. The two photodiode cells A and B are isolated by two P+ diffusions that extend through the N-EPI region and contact the P-SUBSTRATE. An island of N-ERI is formed between the two P+ isolation diffusions. This island forms an additional diode that collects any stray photocurrent that might migrate from under photodiode cell A and otherwise be collected by photodiode cell B. The additional diode also collects any stray photocurrent that might migrate from under photodiode cell B and be otherwise collected by photodiode cell A. Together, the two P+ isolation diffusions and the N-EPI island in between them form the A/B isolation region. The three elements of the A/B isolation region are all shorted by the first metal layer M1, which is connected to ground at the top metal layer TM. Any photocurrent collected in the composite A/B isolation region is shunted to ground, reducing crosstalk between photodiode cell A and photodiode cell B.

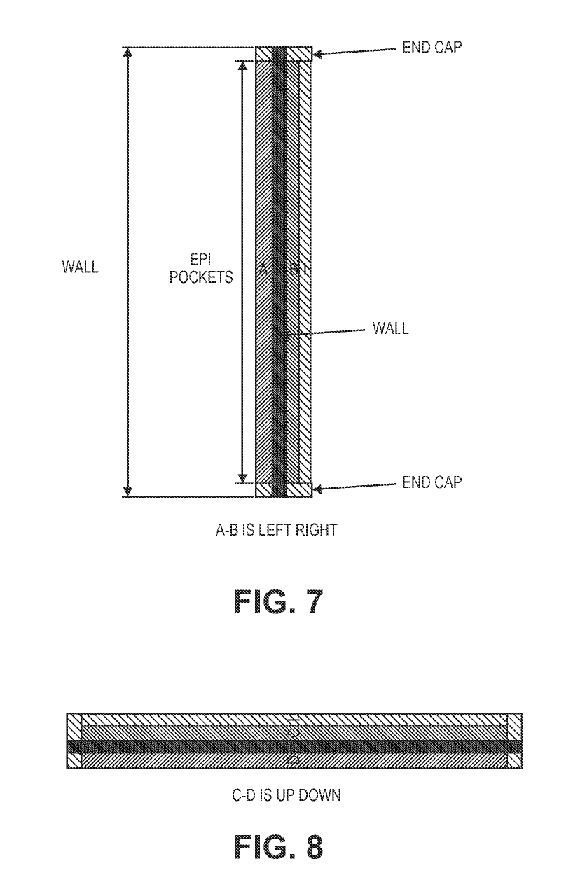

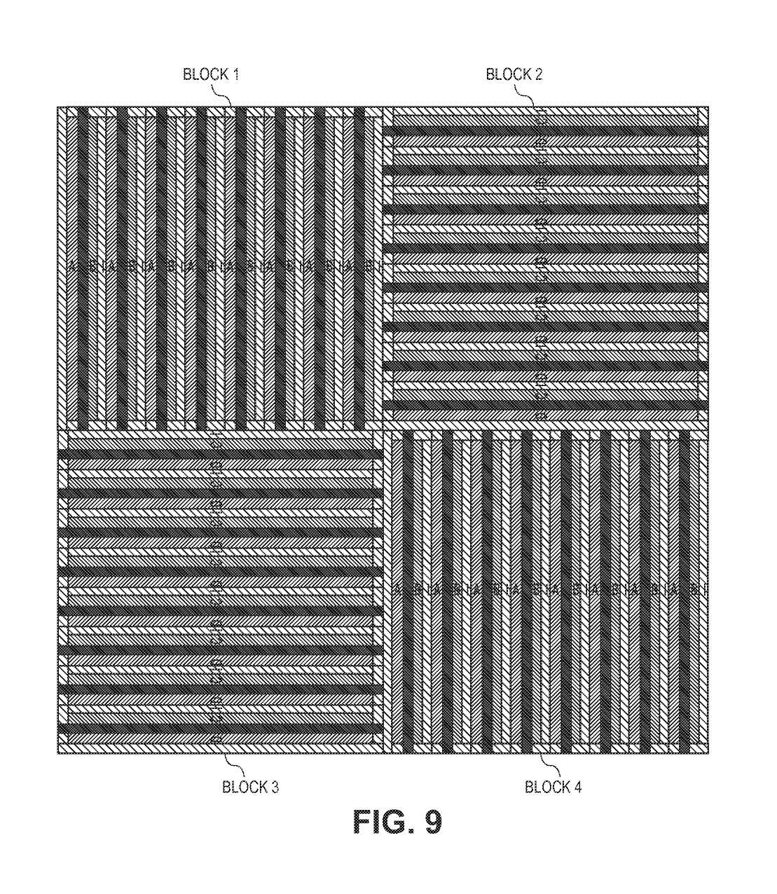

The structure in FIG. 6 is a cell that includes photodiode cell A, photodiode cell B, the isolation region, and the wall. FIG. 7 illustrates a top down view of the cell of FIG. 6. This cell is configured to determine left-right motion as the wall is aligned perpendicularly to the direction of motion, left-right, to be determined. To determine up-down motion, the cell is rotated 90 degrees, as shown in FIG. 8. In the cell configuration of FIG. 8, the wall structure is aligned perpendicularly to the up-down motion to be determined. A reason for creating cells is that the size of the photodiode cells is restricted, specifically the width of the photodiode cell extending away from the wall structure. This limits the surface area that can be used to measure the reflected light. FIG. 9 illustrates a top down view of a plurality of cells configured to form four blocks according to an embodiment of the present disclosure. Respective cells are isolated from an adjacent cell by an isolation region I. In FIG. 9, block 1 is made of an array of alternating photodiode cells A and B. Block 1 is identical to block 4, which also includes an array of alternating photodiode cells A and B. All of the photodiode cells A in both blocks 1 and 4 are electrically connected together to form an aggregated A node. Electrically connecting (e.g., aggregating) the array of cells may increase signal strength. Likewise, all of the photodiode cells B in both blocks 1 and 4 are aggregated together to form a single B node. The same connection scheme is used to form a C node and a D node from the array of alternating photodiode cells C and D in blocks 2 and 3. The photodiode cells in blocks 2 and 3 are rotated 90 degrees relative to the photodiode cells in blocks 1 and 4. In this manner, there are four distinct signals, one from respective nodes A, B, C, and D.

Target motion in the left-right and up-down directions is again determined by analyzing differential signals. To determine target motion in the left-right direction, the differential signal is formed. The differential signal A−B is analyzed in a similar manner as the differential composite signal (A+C)−(B+D) related to the quad cell configuration of FIG. 3A. To determine target motion in the up-down direction, the differential signal C−D is formed. The differential signal C−D is analyzed in a similar manner as the differential composite signal (A+B)−(C+D) related to the quad cell configuration of FIG. 3A.

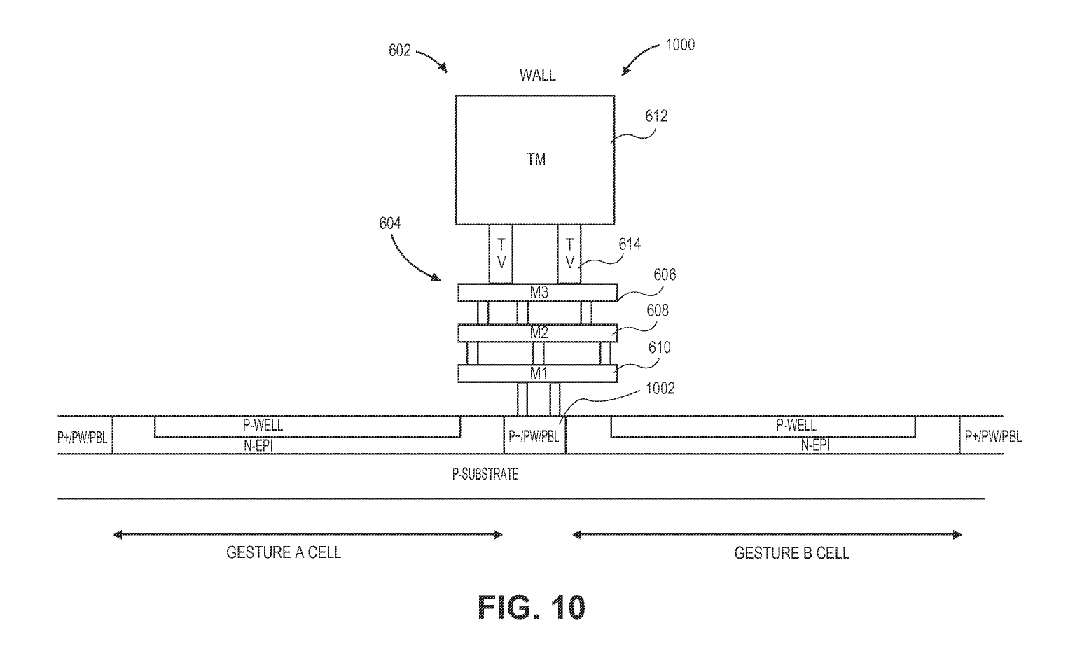

The cell structure shown in FIG. 6 is an example sundial configuration. FIG. 10 illustrates a cross-sectional view of a mechanical structure 1000 employing a sundial configuration according to another embodiment. In the configuration illustrated in FIG. 10, the wall is alternatively formed, and the underlying substrate is alternatively doped. In this embodiment, the isolation region between the two photodiode cells A and B consists of a single P+ diffusion region 1002. The smaller isolation region of FIG. 10 compared to that of FIG. 6 allows for increased packing density. P-WELL and N-EPI region contacts are made at the end of the array. The P+ region in the substrate is connected to ground at the top metal layer TM.

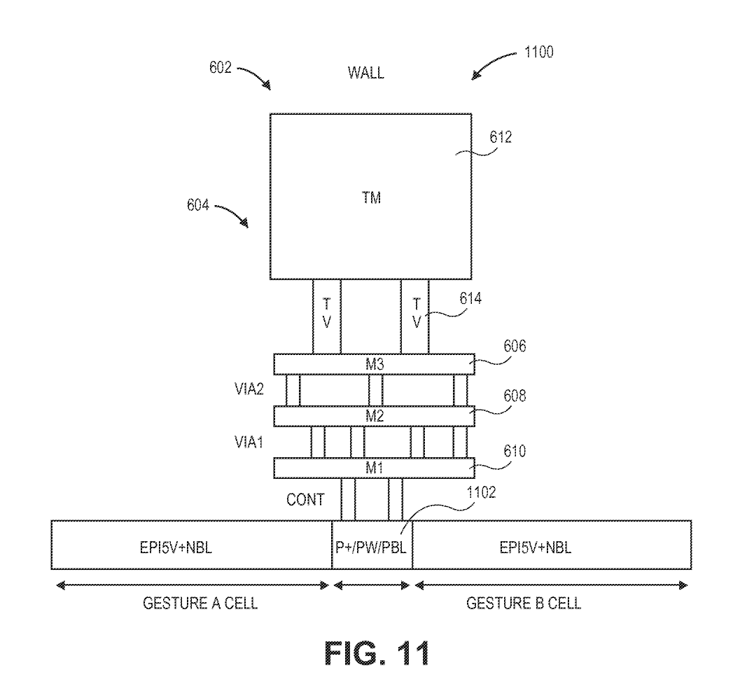

FIG. 11 illustrates a cross-sectional view of a mechanical structure 1100 employing a sundial configuration according to yet another embodiment. In the configuration shown in FIG. 11, the wall is alternatively formed, and the underlying substrate is alternatively doped. The photodiode cells do not include a P-WELL in this configuration. The N-EPI region contacts are made at the end of the array. The P+ isolation region 1102 between the photodiode cells A and B is connected to ground at the top metal layer TM. In this embodiment, the absence of the P-WELL layer permits the fabrication of narrower photodiode cells A and B compared to that of FIG. 6. This structure affords higher cell packing density compared to that of FIG. 6.

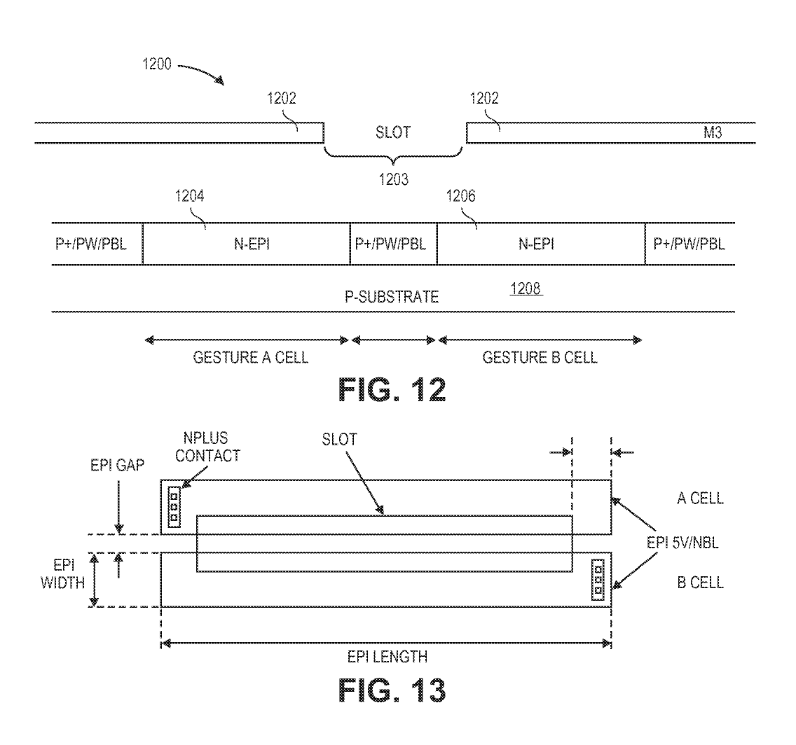

The device 10 may also employ a mechanical structure 1200 employing a pinstripe configuration. FIG. 12 illustrates a cross-sectional view of the mechanical structure 1200 employing the pinstripe configuration according to an embodiment. The pinstripe configuration includes a structure 1202 defining a slot 1203 for directing reflected light onto a photosensor, in this case a photodiode. The pinstripe configuration is analogous to a pinhole camera, where the pinhole has been elongated into a slot 1203 (e.g., stripe). The two N-EPI regions 1204, 1206 in the substrate form the cathodes of photodiode cells A and B, with the P-SUBSTRATE 1208 forming the common anode. A metal layer M3 is formed over the cell to form the structure 1202, and a slot 1203 is formed in the metal layer. The metal layer is formed over an interlayer dielectric, such as silicon dioxide, which is optically transparent. In some embodiments, the cell structure is formed using conventional CMOS, digital semiconductor manufacturing processes. FIG. 13 illustrates a top down plan view of the cell of FIG. 12. As shown in FIG. 13, the open slot is aligned along a length of the cell. The open slot can run the entire length or partial length of the cell.

In operation, reflected light passes through the open slot and impinges the photodiodes, N-EPI sections. When a target position is on the right side of the open slot, light reflected from the target passes through the open slot and impinges the left side photodiode cell A. As the target moves from right to left, more reflected light impinges the left side photodiode cell A until the target passes a critical angle where less reflected light impinges the left photodiode cell A and instead, reflected light begins to impinge the right side photodiode cell B. When the target is directly overhead the slot, at a crossover point, the signals received from the photodiode cells A and B are the same. This is the position of highest overall signal strength, and is also where the difference between the two signals, A−B, is zero. As the target continues moving to the left, more reflected light impinges the right side photodiode cell B, and the difference signal A−B, becomes negative (e.g., the signal value transitions from a positive value to a negative value). After further leftward motion of the target, zero reflected light impinges the left side photodiode cell A. Similarly to the sundial configurations, a plurality of cells of the pinhole configuration are adjacently positioned to form a block, and the signals from the individual photodiode cells A are electrically connected together to form the common A node. The same type of signal aggregation is used for the B through D signals. The alignment of the open slot determines the direction of target motion to be determined. For example, the horizontal alignment of the open slot in FIG. 13 is used to determine up-down motion. A plurality of cells aligned such as the cell in FIG. 13 form a segment configured to measure up-down motion. Vertical alignment of the open slot is used to determine left-right motion. In an example configuration, the segments having the pinstripe configuration are aligned in a similar manner as those segments having the sundial configuration as shown in FIG. 9 where segments A and D are configured to determine left-right motion and segments B and C are configured to determine up-down motion. Target motion in the left-right and up-down directions is determined using the differential signals in the same manner as the sundial configuration described above.

In other configurations, the metal layer and open slot can be replaced by any type of light obscuring element that enables light to enter through a defined area and block light elsewhere, such as a MEMS (micro-electro-mechanical systems) device or other levered, or partially floating element, where the obscuring element is supported by an optically transparent material or suspended over air proximate the open slot. A MEMS device is a very small mechanical device driven by electricity.

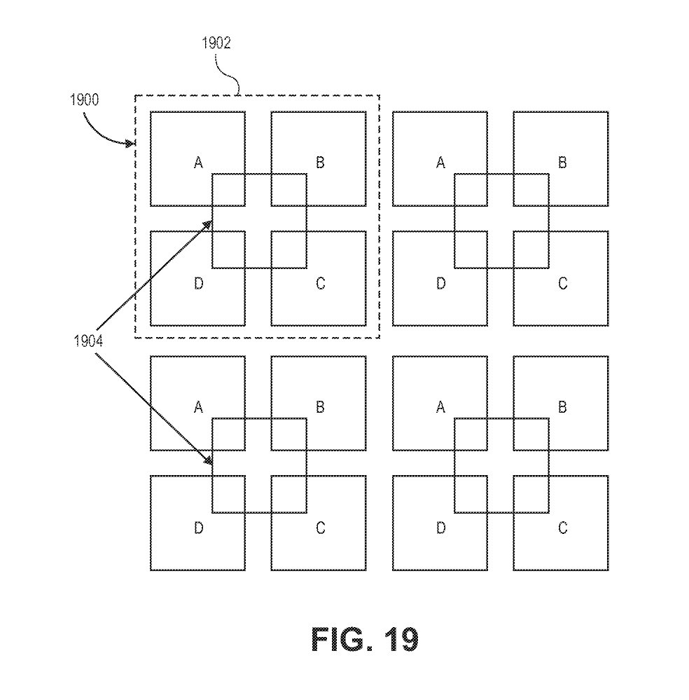

Another embodiment is the application of the pinstripe concept to the quad cell design to produce a micro quad cell structure 1900. FIG. 19 illustrates a top down view of a micro quad cell configuration according to an embodiment. The micro quad cell includes an array of quad cells 1902. One or more of the individual A segments are electrically connected together to form a single A signal, and likewise so are the B, C, and D segments. The array of quad cells is covered by a metal layer defining an opening 1904 that allows the passage of light. The metal layer is formed in a manner similar to that described for the pinstripe concept, using a semiconductor process. The dimensions of the quad cells A through D, the metal layer spacing, and the dimension of the opening in the metal layer are consistent with the dimensions typically available in semiconductor processes. The openings 1904 in the metal layer are positioned so that when light is directly overhead the opening, all cells are equally, but partially illuminated. When the angle of the light changes, the relative illumination of the four cells becomes imbalanced. The four signals, A through D, are processed in a manner identical to that described previously for FIG. 3A.

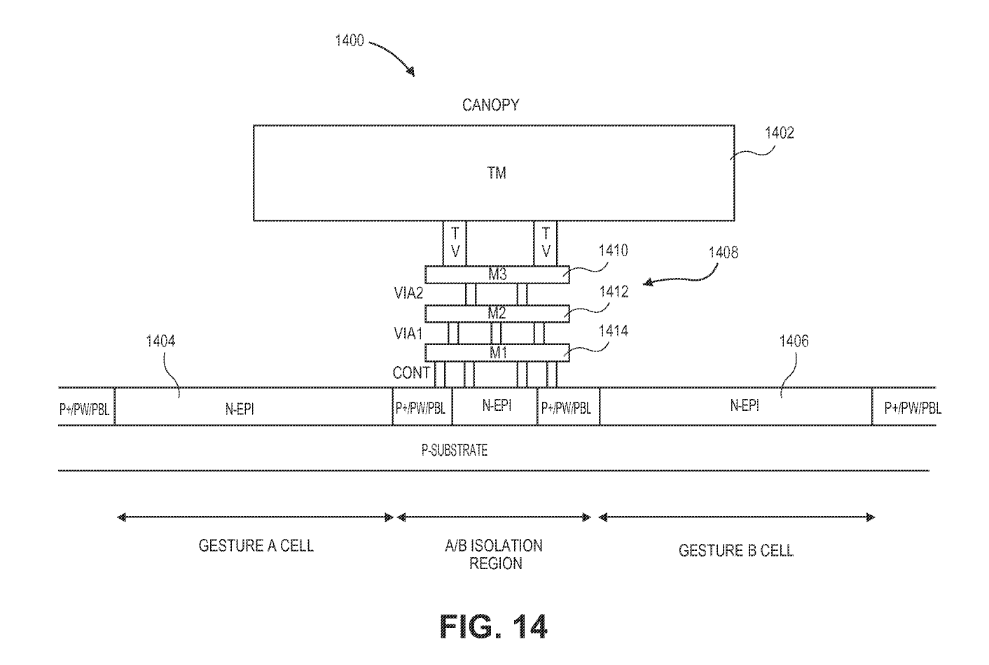

The device 10 may employ a mechanical structure 1400 referred to as a canopy configuration. The canopy configuration operates similarly as the pinstripe configuration except that instead of reflected light accessing the photodiodes of a cell through an open slot in the center of the cell structure, as in the pinhole configuration, the center of the cell structure is covered by a structure 1402 (e.g., a “canopy”) and the peripheral sides of the structure are open to allow reflected light to access the photodiodes of the cell. FIG. 14 illustrates a cross-sectional view of a canopy configuration according to an embodiment of the present disclosure. The canopy configuration provides a structure for directing reflected light onto a photo sensor, in this case a photodiode. The two N-EPI regions 1404, 1406 form photodiode cells A and B. A top metal layer TM forms a canopy structure 1402 over the center of the cell structure, thereby covering an inner portion of the photodiodes and not covering an outer portion. The top metal layer (e.g., structure 1402) is a top layer of a wall 1408 formed as a series of metal layers 1410, 1412, 1414 built that separate the two photodiode cells A and B. The wall structure 1408 is formed in a similar manner as the wall structures of the sundial configurations, except that the top metal layer TM of the canopy configuration extends over inner portions of the two photodiode cells A and B. The portion of the top metal layer TM that extends over the two photodiodes cells A and B is formed over an interlayer dielectric, such as silicon dioxide, that is optically transparent. Similarly to the pinstripe configuration and sundial configurations, a plurality of cells of the canopy configuration are adjacently positioned to form a segment, and multiple segments are configured and oriented to determine left-right and up-down motion. Reflected light is sensed by the photodiode cells A and B, and the sensed voltage is collected and processed similarly as for the pinstripe configuration and sundial configuration described above.

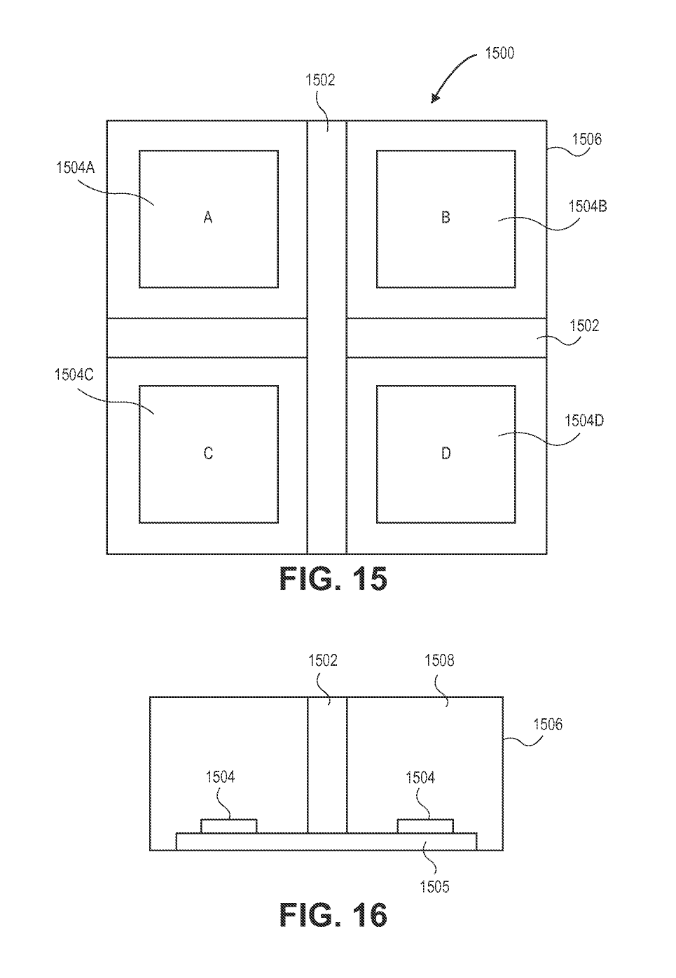

The device 10 may employ a mechanical structure 1500 referred to as a corner quad configuration. The corner quad configuration is similar conceptually to the sundial configuration in the use of a physical wall 1502 positioned between photo sensing devices 1504 (e.g., photodiodes 1504A to 1504D), but instead of implementing the wall at the silicon level and having a plurality of cells for the segments, as in the sundial configuration, the corner quad configuration is implemented at the chip package level where a wall 1502 is formed between the segments. FIG. 15 illustrates a top down view of a corner quad configuration according to an embodiment. FIG. 16 illustrates a cross-sectional view of the corner quad configuration of FIG. 15. In the example configuration shown in FIGS. 15 and 16, photo sensor segments A-D are formed as four photodiodes on an integrated circuit chip. The four photodiodes can be considered as identical to the four photodiodes of FIG. 3A, except that instead of using the closely spaced quad geometry of FIG. 3A, the photodiodes are instead spaced apart and placed in the four corners of the substrate. The integrated circuit chip 1505 is packaged in a chip package 1506 that includes a wall 1502 made of optically opaque material that blocks light, such as the light reflected from a moving target. The portion of the chip package above the photodiodes is made of an optically transparent material 1508. The height of the wall 1502 in the corner quad configuration is high enough so that respective segments comprise a single sensor element, as opposed to a plurality of cells as in the sundial and canopy configurations. Determination of the target motion is determined in a similar manner as the sundial configuration without having to aggregate the individual cell voltages for a given segment. The corner quad configuration includes a wall 1502 that has a chip package level of magnitude versus the sundial configuration that includes a wall that has a transistor level of magnitude.

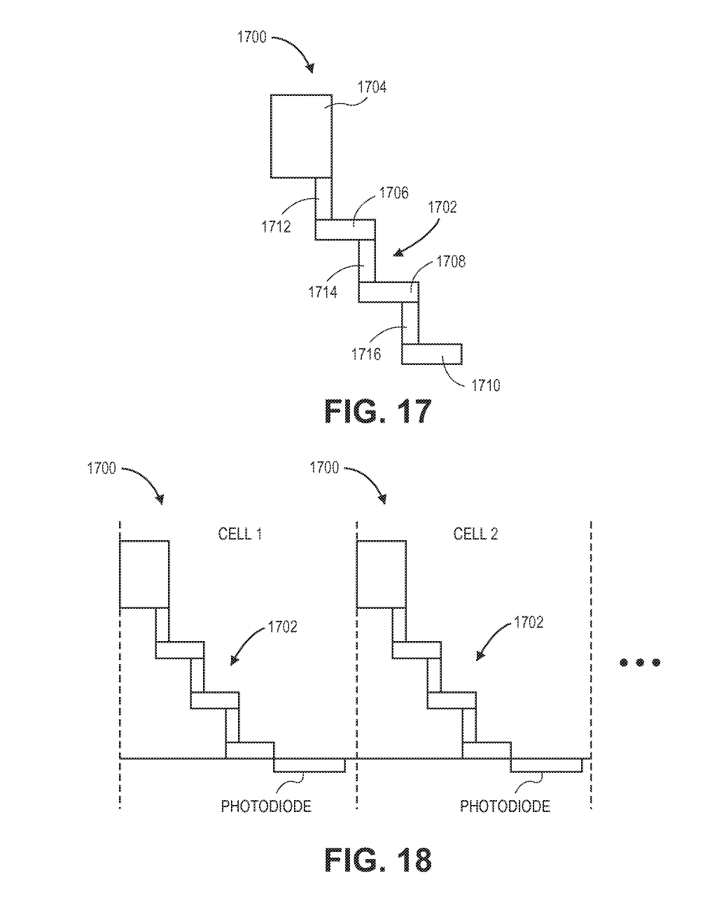

The device 10 may also include a mechanical structure 1700 referred to as a Venetian blinds configuration. The Venetian blinds configuration is similar to the sundial configuration except that the wall structure 1702 in respective cells are formed at a non-perpendicular angle to the photodiode cell(s), as opposed to the perpendicular angle as in the sundial configuration. The angled walls 1702 are fabricated by forming metal layers 1704, 1706, 1708, 1710 and through-vias 1712, 1714, 1716 in a stair step configuration, as shown in FIG. 17. Additionally, respective cells in the Venetian blind configuration include a single photodiode cell positioned on one side of the angled wall, as shown in FIG. 18. In the Venetian blind configuration, respective segments of the four segments may be facing a different 90 degree direction. For example, segment A is configured with the walls angled to the left, segment B is configured with the walls angled upward, segment C is configured with the walls angled downward, and segment D is configured with the walls angled to the right. In other words, respective segments have a different field of view. Using these alignments, target motion in the left-right and up-down directions is determined using the differential signals in the same manner as the sundial configuration described above. It is understood that other alignments can be used.

In some embodiments, filters are added on top of the photo sensors to filter out light having wavelengths that are different than the illumination source.

The example embodiments describe a gesture sensing device 10 having four symmetrically configured segments (e.g., photo sensors). It is understood that the concepts described herein can be extended to more than four segments configured symmetrically or asymmetrically, as in an N×N, N×M, circular, or other shaped array of photo segments or sensors. As previously described, a “segment” refers to either a partitioned segment within a single sensor or to a discrete sensor, such as a photodiode, in an array of sensors.

As previously described, the control circuit is configured to process the segment signals received from the segmented photo sensor. In particular, the control circuit includes an algorithm intended to recognize both the direction and speed of a gesture in two dimensions, for example some combination of left, right, up and down, to result in a “gesture vector”. This can be extended to larger arrays of photodiodes to allow the formation of vector fields, which further increases the accuracy of the algorithm. A vector can be used for command identification, subsequent processing, or other application-specific uses. By being able to track speed, the effective number of recognizable gestures can be increased by a factor of two, if only “slow” and “fast” are used, or more, thereby providing increased functionality. The raw vector data can be used to define predetermined gestures or the raw vector data can be converted to a likelihood that the vector corresponds to one of the four cardinal directions or some other defined set of basis directions.

The algorithm also incorporates gesture recognition along the z-axis, for example toward or away from the segmented photo sensor. In some embodiments, the algorithm also includes finger tracking.

The algorithm is explained in the context of the gesture sensing device of FIG. 3A. The light source 11 illuminates the target, which moves over the segmented sensor 12, resulting in light reflected off the target impinging the segmented sensor. The light modifying structure 13 conceptually represents any means for directing reflected light onto the segmented sensor 12, where the means for directing includes, but is not limited to, the optical means and mechanical means previously described. The image formed on the segmented sensor moves in a translated fashion related to the target motion. Composite signals are derived from the segmented signals output from the four segments A, B, C, D. Motion is determined by addition and subtraction of the segments signals, taken in different combinations for the two axes, X and Y, where the x-axis corresponds to left and right motion and the y-axis corresponds to up and down motion. Motion in the left and right direction is determined according to X=(A+C)−(B+D), and motion is the up and down direction is determined according to Y 32 (A+B)−(C+D). Motion toward or away from the segmented sensor, in the z-axis, is the total amount of light impinging all segments and is determined according to Z=A+B+C+D.

When an image moves from left to right over the segmented sensor, composite signal X first increases from zero to some positive value, then decrease below zero to some negative value before finally returning to zero. If the motion is purely in the x-direction, then the composite signal Y does not change much, and if it does, it only moves in one direction due to the segments being asymmetrically illuminated by a lighting source. The composite signal Z increases with illumination, regardless of the direction of movement along the x-axis or y-axis.

It is understood that the relationship between the direction of target motion and the corresponding direction of image motion on the sensor is dependent on the light directing mechanism used to direct reflected light onto the segmented sensor. FIG. 3A shows example target motion from right to left. As previously described, target motion is inversely translated as image motion on the segmented sensor 12. For right to left target motion, there is corresponding left to right image motion, and vice versa. Similarly, for up to down target motion, there is corresponding down to up image motion, and vice versa. In the examples described above, there is an opposing relationship where the target motion direction is opposite that of the image motion direction. Other relationships are also contemplated.

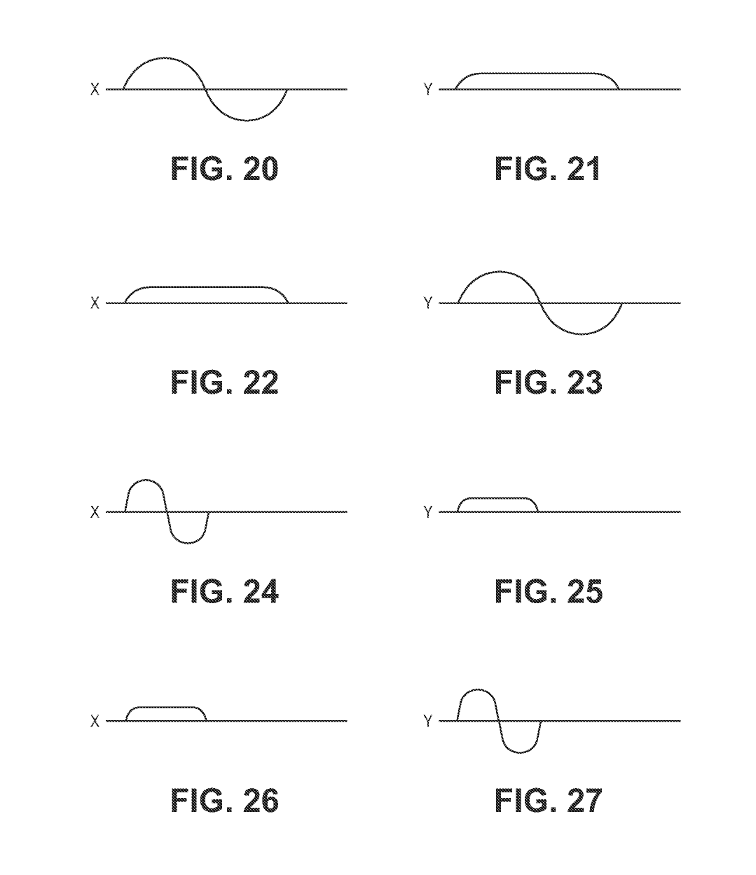

FIG. 20 illustrates an example waveform corresponding to left to right image motion across the segmented sensor 12 of FIG. 3A. Left to right image motion corresponds to right to left target motion. As the target moves from the far right toward the segmented sensor 12, an image eventually begins to appear on the segments A and C. As the target continues moving from right to left, more and more of the target is imaged onto the segments A and C, resulting in an increasing X value. At some point, a maximum image is sensed on segments A and C, which corresponds to the point just prior to the image impinging the segments B and D. This point corresponds to a maximum X value, exemplified in FIG. 20 as the positive peak of the sinusoidal waveform. As the target moves further to the left, the image moves further to the right and begins impinging the segments B and D. In the formula for calculating the value X, a positive value for B+D is subtracted from A+C resulting in a declining value of X. Eventually, as the target moves leftward to a point where half the image impinges the segments A and C and half the image impinges the segments B and D, which corresponds to the middle zero crossing in FIG. 20. As the target continues moving to the left, the image continues moving to the right, impinging more and more of segments B and D and less and less of segments A and C, resulting in a greater and greater negative value of X. Eventually, the value of X reaches a negative maximum that corresponds to the position of the target where the image no longer impinges the segments A and C and impinges a maximum amount of the segments B and D. As the target moves further and further to the left, less and less image impinges the segments B and D until the target reaches a position where there is no corresponding reflected light impinging any of the segments, which corresponds to the right-most zero crossing in FIG. 20.

FIG. 21 illustrates an example waveform corresponding to up to down image motion across the segmented sensor 12 while the target motion is from right to left as in FIG. 20. The example waveforms shown in FIGS. 20 and 21 correspond to target motion purely in the x-direction. Ideally, the Y value for purely x-direction target motion is zero. However, in practice, some non-zero value is typically determined due to the segmented sensor being asymmetrically illuminated by the LIGHT SOURCE 11. The waveform shown in FIG. 21 shows a positive non-zero value, but is intended to represent some trivial non-zero value, which may be positive, negative, zero, or some combination over time.

FIG. 23 illustrates an example waveform corresponding to up to down image motion across the segmented sensor 12 of FIG. 3A. Up to down image motion correspond to down to up target motion. The waveform shown in FIG. 23 corresponds to the composite signal Y and is determined similarly as the waveform corresponding to the composite signal X shown in FIG. 20. The positive values of Y correspond to reflected light impinging exclusively or predominately in segments A and B, and the negative values of Y correspond to image impinging exclusively or predominately in segments C and D. The zero crossings correspond to either zero image impinging the segments A, B, C, and D, or an equal amount of image impinging segments A+B as impinging segments C+D.

FIG. 22 illustrates an example waveform corresponding to left to right image motion across the segmented sensor while the target motion is from down to up as in FIG. 23. The example waveforms shown in FIGS. 22 and 23 correspond to target motion purely in the y-direction. Ideally, the X value for purely y-direction target motion is zero. However, in practice, some non-zero value is typically determined due to the segmented sensor being asymmetrically illuminated by the LIGHT SOURCE 11. The waveform shown in FIG. 22 shows a positive non-zero value, but is intended to represent some trivial non-zero value, which may be positive, negative, zero, or sonic combination over time.

To determine a gesture in the z-direction, we must look for a sufficient increase in the Z, or VSUM, signal (A+B+C+D) without there being a vector detected in either the x or y direction.

Referring to FIGS. 20 and 23, the positive and negative zero-crossings coincide with the image moving from one side of the segmented sensor to the other. Therefore, the faster the target moves, the faster the image crosses from one side of the segmented sensor to the other, and thereby causes the waveform's zero-crossings to be spaced closer in time. This correlates exactly to velocity. FIGS. 24-27 illustrate waveforms similar to the waveforms of FIGS. 20-23, respectively, except that the target motion corresponding to the waveforms in FIGS. 24-27 is faster than the target motion corresponding to the waveforms in FIGS. 20-23. The waveforms in FIGS. 24-27 have a relationship analogous to the waveforms in FIGS. 20-23, respectively. The waveforms corresponding to faster target motion, such as the waveforms shown in FIGS. 24-27, have a shorter period, or are compressed, compared to waveforms corresponding to similar yet slower target motion, such as the waveforms shown in FIGS. 20-23.

The reflected light is sampled at a predetermined rate, for example once a millisecond. At time zero the X value starts going positive, as shown in FIG. 20. At a later time, such as time equals 30 milliseconds, the X value crosses zero and becomes negative. Divide the sampling rate by the time between zero crossings and the result is a value proportional to the velocity. This is a crude estimate of target velocity as there are other contributing factors, such as distance of the target from the sensor, but this estimate provides an accurate relative velocity compared to the other direction, for example a relative velocity in the x-direction compared to the y-direction since the estimated velocity in both the x and y directions can be calculated using the respective zero crossings and then subsequently compared to each other. An example application is to use the estimated velocity determination as a course-level command, where different commands are determined based on a different estimated velocity. For example, a displayed object can be commanded to rotate at a fast rate if the determined estimated velocity is greater than a high threshold value, a medium rate if the determined estimated velocity is between the high threshold value and a low threshold value, or a slow rate if the determined estimated velocity is lower than the low threshold value.

The above are examples of waveforms resulting from gestures, or target motion, either purely in the x or y directions. However, many gestures may contain components of both directions, such as a diagonal target motion, and gesture waveform amplitudes may vary from case to case. Therefore, it is reasonable to look for the relative change between positive and negative, specifically zero-crossings, and to do so for both the left-right and up-down channels simultaneously. In the case where target motion is not purely left-right or up-down, the resulting X and Y signal waveforms may vary in both amplitude and period.

Using the information obtained in the composite signal X and the composite signal Y, a two-dimensional vector can be determined. If it is specified that a zero crossing must be followed by a zero crossing in the opposite direction to identify a gesture on either the left-right or up-down channels, and the first zero crossing occurs at time t1 and the second zero crossing occurs at time t2, then the velocity along either the x or y direction is proportional to 1/(t2−t1). The direction is determined by whether or not the first zero crossing is negative or positive. Doing this for both the left-right and up-down channels allows the x-direction velocity Vx and the y-direction velocity Vy to be superimposed into a two-dimensional vector in the form Vxi+Vyj using Cartesian coordinates. The Cartesian coordinates are readily converted to polar coordinates including a vector angle. The result is that target motion can be detected along any angle and any velocity in the x,y plane, limited only by the sampling rate. The greater the sampling rate, the finer the resolution of the vector angle. For example, in the case where the determined velocity Vx is greater than velocity Vy, it can be determined that the target is moving more in a left-right direction than an up-down direction.

In some embodiments, various angle thresholds can be defined, and the vector angle is compared to the angle thresholds. For example, a vector angle between +45 degrees and +135 degrees is determined to be an up target motion, and a vector angle between +45 degrees and −45 degrees is determined to be a right target motion. The algorithm can also be asymmetrically weighted. For example, a vector angle of 60 degrees may still be determined as a right target motion although the vector points more toward 90 degrees corresponding to the up target motion. Such an example illustrates the general concept that the algorithm can be programmed to take into account prior gesture distributions, which can be uniform or non-uniform.

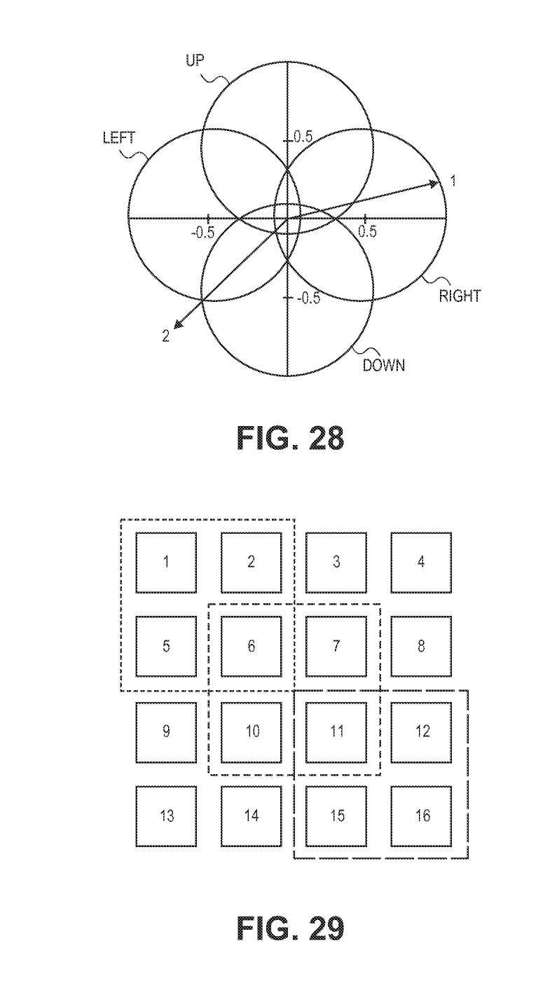

This concept can be extended by using vectors with a set of probabilistic likelihood functions to plot the confidence that a target motion is in a particular, defined direction. In this manner, the user does not have to make as precise a gesture for the gesture to be recognized as one of the defined target motion directions, such as left, right, up, and down. This can also compensate for certain noise that may have been introduced. For example, if the user wants to recognize only left to right, up to down, right to left, and down to up directions, four likelihood functions can be defined, such as Gaussian distributions, with maxima centered at each desired vector, and half-maximum exactly halfway (radially) between the neighboring desired vectors. FIG. 28 illustrates four Gaussian distributions corresponding to recognized directions left, right, up, and down. In this example, the maxima occur at 0 degrees (right), +90 degrees (up), −90 degrees (down), and 180 degrees (left), with the half-maxima occurring at +45 and +135 degrees. In this example, each direction is equally likely to occur. Given some vector, the vector angle with respect to 0 degrees (positive x-direction) is determined, and the likelihood of the vector corresponding to all four likelihood distributions is calculated. The largest of these values is thereby the “most likely” and is decided to be the target motion. Two example vectors are shown in FIG. 28, where each vector corresponds to a measured target motion. Vector 1 is determined to be a left to right motion having a 90% confidence. Vector 2 is determined to be ambiguously up to down and right to left because the vector is equally likely to be in the left circle and the down circle. In some embodiments, the algorithm is programmed to provide a predefined result in the case of each such ambiguity. In other embodiments, the algorithm is programmed to not respond to an ambiguous result or to generate an error message or indicator. As described above, the algorithm is applied to a four segment sensor. The segmented sensor and the algorithm are adaptable for use with a sensor having more than four segments, for example an N×N or N×M array of segments. FIG. 29 illustrates an example 4×4 array of photodiode segments. A vector can be determined for each of nine different four-segment arrangements. For example, a first four-segment arrangement includes segments 1, 2, 5, and 6, a second four-segment arrangement includes segments 6, 7, 10, and 11, a third four-segment arrangement includes segments 11, 12, 15, and 16, and so on. By applying the algorithm for the nine, four-segment arrangements, a vector field can be assembled that can be used to in more complex target motion information.

The gesture sensing device is described as using a single illumination source, such as light source 11 is FIG. 3A. However, in some embodiments, the single illumination source is intended to represent one or more illumination sources that are concurrently pulsed, as opposed to multiple illumination sources that are serially pulsed as in the conventional device of FIG. 1. By using multiple illumination sources that are pulsed at the same time, a wider coverage area can be achieved. The coverage area of a given illumination source is defined as that area above the illumination source where light reflecting off a target that is within the coverage area will impinge the sensor. The coverage area coincides with the field of view of the segmented sensor. Although light from the illumination source may impinge the target at areas outside the coverage area, it is only while the target is within the coverage area will the reflected light be angled to impinge the segmented sensor. Outside the coverage area, reflected light is not angled properly to impinge the segmented sensor. More than one illumination source, pulsed concurrently, functions to increase the coverage area.

More than one illumination source can also be used with the segmented sensor where the illumination sources are not pulsed concurrently. In this manner, multiple x-channels and multiple y-channels can be implemented, a first x-channel and a first y-channel corresponding to a first illumination source, and so on.

The gesture sensing device and algorithm can also be adapted for use with no illumination source. Instead of detecting the image corresponding to reflected light originating from an illumination source, the ambient light is detected and a decrease in the ambient light resulting from a passing target is determined. In this manner, a passing target casts a shadow over the segmented sensor, where the shadow is measured as a decrease in ambient light. The shadow in an ambient light configuration is inversely analogous to an image in an illumination source configuration. In the ambient light configuration, a polarity of the three composite signals X, Y, and Z is reversed.

The gesture sensing device and algorithm can also be used as a finger tracking application. By analyzing the instantaneous values of the composite signals X and Y, a current location of the target, such as a finger, can be determined. For example, if the value of the composite signal X is positive, or some value greater than some predetermined X positive threshold value, and the value of the composite signal Y is zero, or some near zero value that does not exceed some Y near zero threshold value, then it is determined that a user's finger is positioned to the left of the segmented sensor. Similarly, if the value of the composite signal X is zero, or some near zero value that does not exceed some X near zero threshold value, and the value of the composite signal Y is negative, or some value greater than some predefined Y negative threshold value, then it is determined that the user's finger is positioned below the sensor. If the value of the composite signal X is positive and the value of the composite signal Y is negative, then the user's finger is determined to be positioned near the bottom left corner of the sensor. In this manner, nine positions can be determined. Eight of the positions are around the perimeter, which are the four corners, left, right, up, and down. The ninth position is the center of the segmented sensor, which corresponds to when the value of the composite signal X and the value of the composite signal Y are both zero, but the Z, or VSUM, signal (A+B+C+D) is not zero. Tracking successive finger positions also determines a vector. For example, three successive finger positions that correspond to left of sensor, center of sensor, and right of sensor, indicates a right to left target motion. In this manner, finger tracking that leads to a vector determination is a more complex method of determining a target motion vector. Finger tracking can also be used for simpler applications, such as a single finger position, instead a sequence of successive finger positions, that indicates a command

The gesture sensing device has been described in terms of specific embodiments incorporating details to facilitate the understanding of the principles of construction and operation of the gesture sensing device. Such references, herein, to specific embodiments and details thereof are not intended to limit the scope of the claims appended hereto. It will be apparent to those skilled in the art that modifications can be made in the embodiments chosen for illustration without departing from the spirit and scope of the gesture sensing device.

Generally, any of the functions described herein can be implemented using hardware (e.g., fixed logic circuitry such as integrated circuits), software, firmware, manual processing, or a combination of these implementations. Thus, the blocks discussed in the above disclosure generally represent hardware (e.g., fixed logic circuitry such as integrated circuits), software, firmware, or a combination thereof. In the instance of a hardware implementation, for instance, the various blocks discussed in the above disclosure may be implemented as integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software implementation, for instance, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A gesture sensing device comprising:
a single illumination source configured to emit light;
a light sensor assembly configured to detect the light reflected from an object and to output time dependent signals in response thereto; and
a processing circuit coupled to the light sensor assembly and configured to analyze the time dependent signals received from the light sensor assembly and to determine object directional movement proximate to the light sensor assembly.

2. The gesture sensing device as recited in claim 1, wherein the single illumination source comprises one or more light emitting diodes.

3. The gesture sensing device as recited in claim 1, wherein the single illumination source comprises a single light emitting diode.

4. The gesture sensing device as recited in claim 1, wherein the single illumination source comprises one or more vertical-cavity surface-emitting laser.

5. The gesture sensing device as recited in claim 1, wherein the single illumination source comprises a single vertical-cavity surface-emitting laser.

6. The gesture sensing device as recited in claim 1, further comprising a light modifying structure configured to relay light to the light sensor assembly.

7. The gesture sensing device as recited in claim 6, wherein the light modifying structure comprises a mechanical structure configured to selectively block a portion of the light depending on a position of the object relative to the light sensor assembly.

8. The gesture sensing device as recited in claim 7, wherein the mechanical structure comprises at least one wall structure, the at least one wall structure disposed at a non-perpendicular angle to a top surface of the light sensor assembly.

9. The gesture sensing device as recited in claim 8, wherein the at least one wall structure comprises a plurality of metal layers and a plurality of through-vias configured in a stair-step structure.

10. The gesture sensing device as recited in claim 1, wherein the light sensor assembly comprises a microlens.

11. A sensing device comprising:
a single illumination source configured to emit light;
a light sensor assembly configured to detect the light reflected from an object and to output time dependent signals in response thereto;
a light modifying structure configured to relay reflected light to the light sensor assembly; and
a processing circuit coupled to the light sensor assembly and configured to analyze the time dependent signals received from the light sensor assembly and to determine object directional movement proximate to the at least one light sensor.

12. The gesture sensing device as recited in claim 11, wherein the single illumination source comprises a light emitting diode.

13. The gesture sensing device as recited in claim 11, wherein the light sensor assembly comprises a plurality of photodiodes.

14. The gesture sensing device as recited in claim 11, wherein the light sensor assembly comprises an array of individual light sensors.

15. The gesture sensing device as recited in claim 11, wherein the single illumination source comprises a vertical-cavity surface-emitting laser.

16. The gesture sensing device as recited in claim 11, wherein the light modifying structure comprises a mechanical structure configured to selectively block a portion of the light depending on a position of the object relative to the light sensor assembly.

17. The gesture sensing device as recited in claim 16, wherein the mechanical structure comprises at least one wall structure, the at least one wall structure disposed at a non-perpendicular angle to a top surface of the light sensor assembly.

18. The gesture sensing device as recited in claim 17, wherein the at least one wall structure comprises a plurality of metal layers and a plurality of through-vias configured in a stair-step structure.

19. The gesture sensing device as recited in claim 11, further comprising an optical lens structure disposed over the single illumination source, the optical lens structure configured to at least partially collimate the light, the optical lens structure oriented at an angle with respect to an axis perpendicular to a surface of an electronic device.

20. A sensing device having a surface, the sensing device comprising:
a single illumination source configured to emit a light; and
a light sensor assembly having a processing circuit and configured to detect the light reflected from an object proximate to the sensing device and to analyze the light reflected to determine directional movement of the object.
